(19) United States
(12) Patent Application Publication
(10) Pub. No.: US 2008/0316186 A1
(43) Pub. Date: Dec. 25, 2008

(54) Digital notepad

(76) Inventor: Darren O'Brien, Sparks, MD (US)

Correspondence Address: Ober, Kaler, Grimes & Shriver;Attorneys at Law, 120 East Baltimore Street, Baltimore, MD, 21202-1643, US

(21) Appl. No.: 12/080,428

(22) Filed: Apr. 2, 2008

Related U.S. Application Data
(60) Provisional application No. 60/921,426, filed on Apr. 2, 2007.

(51) Int. Cl. G06F 3/041

(52) U.S. Cl. 345/173

(57) ABSTRACT

A digital notepad that is compact, lightweight, very portable, and readily useable for taking and storing digital handwritten notes. The digital notepad is a stand-alone device that instantly and digitally captures everything the user handwrites onto the screen with stylus, and stores it in real time. The device generally comprises a touch screen encased within a housing, and a pen-type stylus for writing on the screen. The device converts the handwritten notes into digital signals and stores the signals in the RAM. The user may retrieve stored notes with the scroll buttons, and delete retrieved notes by depressing the delete button with the stylus. The notepad is especially useful for jotting down notes, daily tasks, grocery lists, phone numbers, e-mail and home addresses, sketches, etc. while in the car; in class; and at a meeting, party, or professional event.

### CROSS-REFERENCE TO RELATED APPLICATION(S)

The present application derives priority from U.S. Provisional application No. 60/921,426 filed Apr. 2, 2007.

### BACKGROUND OF THE INVENTION

1. Field of the Invention

The present invention relates to a digital notepad, and more particularly to a very portable digital notepad that generally comprises a touch screen and stylus for handwritten note entry, a housing enclosing the screen, and minimalist controls including note-review scrolling keys, on/off, and save and new (note) buttons.

2. Description of the Background

Oftentimes while on the go, thoughts run through an individual's head and it is useful to jot those thoughts down so as not to forget them. For example, while in the car or in line at a store an individual may remember tasks that he has to complete during the day or groceries he needs to purchase, and will scribble these notes onto a PostIt® note or other sheet of paper. Other times when at a party or a professional development event, where it may be helpful to write to down contact information, sheets of paper and a pen or pencil may not be available to write with. Also, even if PostIt® notes and other loose sheets of paper are available, notes written thereon can be easily misplaced. Thus, it would be greatly advantageous to provide an alternative to paper notes by offering an electronic note-taking device that is available to an individual for jotting down thoughts while on the go. A number of patent efforts have been made in this regard. For example, U.S. Pat. Nos. 6,806,867B1, 5,237,651, 5,444,192 and U.S. Patent Application Nos. US2002/0173345 and 2004/0001093A1 are directed toward taking electronic notes. While these electronic note-taking devices have furthered technological development, they are too complex in design and function with multiple tools, menus, etc. which are cumbersome and difficult for an average user who simply desires to take notes to use. Prior art devices do not provide an easy way to retrieve previously handwritten notes, as the devices require an extensive knowledge of the device to retrieve notes and utilize recently recorded information. Typically, the user must flip open a prior art device, navigate menus, and find a note recorded just hours earlier, thereby discouraging users from utilizing the notes function of the devices. Also, these devices are either too small for taking notes or are too bulky to fit within a pocket/lapel, and are expensive for users who desire only to jot down short notes. Additionally, because these devices are complex in function as well as in hardware they are impractical and laborious to use.

Thus, there remains a need for a key-fob sized digital notepad that generally comprises a touch screen and stylus for handwritten note entry, a housing enclosing the screen, and minimalist controls including note-review scrolling keys, on/off, and save and new (note) buttons, wherein the digital notepad: (1) instantly records a quick note, address, message, etc. that a user handwrites onto the screen; (2) saves the handwritten note by pressing either the save or new (note) buttons; (3) date and time stamps the saved note; (4) allows a user to quickly and easily retrieve and view a saved note; (5) that attaches to a clear rubber ring and thereby permit the digital notepad to function as a teleprompter; (6) that includes a magnetic strip which permits the digital notepad to be mounted to a number of different surfaces including but not limited to, a dashboard of a car, a PC, a desk, a refrigerator, a phone station, a counter top, a desk top, and doors; (7) that can be enclosed within plastic packaging for sales display; (8) is compact, lightweight, very portable, and convenient digital notepad; (9) is inexpensive to manufacture and sell to provide for widespread use.

### SUMMARY OF THE INVENTION

It is an object of the present invention to provide a digital notepad for instantly jotting down notes, daily tasks, grocery lists, phone numbers, e-mail and home addresses, sketches, etc. while in the car; in class; and at a meeting, party, or professional event.

Another object of the present invention is to provide a digital notepad that is readily useable for taking and storing digital handwritten notes.

It is another object to provide a stand-alone digital notepad with internal storage capability that instantly and digitally captures everything the user handwrites onto the screen.

Another object of the present invention is to provide a digital notepad that easily saves notes by pressing either the save or new (note) buttons.

Yet another object of the present invention is to provide a digital notepad that date and time stamps saved notes.

Still another object of the present invention is to provide a digital notepad that allows a user to quickly and easily retrieve and view saved notes.

Another object of the present invention is to provide a digital notepad that attaches to a clear rubber ring and thereby permit the digital notepad to function as a teleprompter.

Still another object of the present invention is to provide a digital notepad that includes a magnetic strip which permits the digital notepad to be mounted to a number of different surfaces including but not limited to, a dashboard of a car, a PC, a desk, a refrigerator, a phone station, a counter top, a desktop, and doors.

It is another object of the present invention to provide a digital notepad that can be enclosed within plastic packaging for sales and marketing display.

It is another object of the present invention to provide a compact, lightweight, very portable, convenient digital notepad.

It is still another object of the present invention is to provide a digital notepad that is inexpensive to manufacture and sell to provide for widespread use.

In accordance with the foregoing objects, the present invention is a digital notepad that is a stand-alone device that instantly and digitally captures everything the user handwrites onto the screen with stylus, and stores it in real time. The device generally comprises a touch screen encased within a housing, and a pen-type stylus for writing on the screen. The device converts the handwritten notes into digital signals and stores the signals in the RAM. The user may retrieve stored notes with the scroll buttons, and delete retrieved notes by depressing the delete button with the stylus.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1A is a plan view of the digital notepad device 1 according to a preferred embodiment of the present invention.

FIG. 1B is a bottom view of the digital notepad device 1.

FIG. 1C is a rear view of the digital notepad device 1.

FIG. 2 is a rear view of an alternate embodiment of the invention.

FIG. 3 shows the digital notepad 1 enclosed within plastic packaging 17.

FIG. 4 is a schematic block diagram illustrating the major circuitry of the device 1.

FIG. 5 is a flowchart illustration of the operation of the device 1.

### DETAILED DESCRIPTION OF THE PREFERRED EMBODIMENTS

The present invention, named NoteIt™, is a digital notepad 1 that is compact, lightweight, very portable, and readily useable for taking and storing digital handwritten notes. The digital notepad 1 is a stand-alone device that instantly and digitally captures everything the user handwrites onto the screen 2 with a stylus 4, and stores it in real time which will be described in further detail below. The notepad 1 is especially useful for jotting down notes, daily tasks, grocery lists, phone numbers, e-mail and home addresses, sketches, etc. while in the car; in class; and at a meeting, party, or professional event.

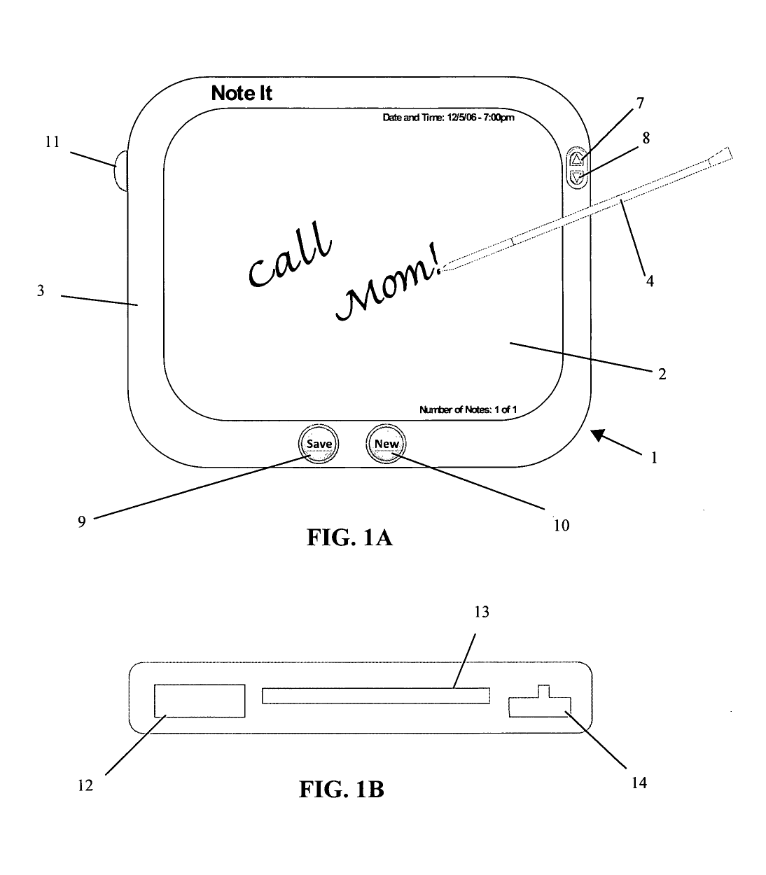

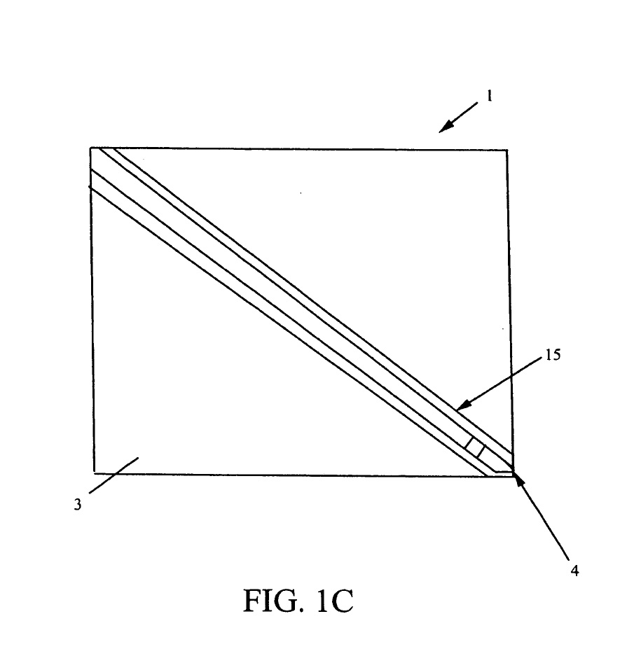

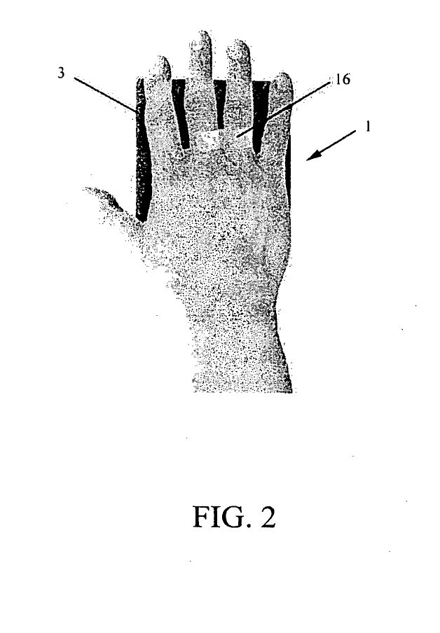

FIGS. 1A-C show plan, bottom, and rear views, respectively of the digital notepad device 1 according to a preferred embodiment of the present invention. The device 1 generally comprises a touch screen 2, a housing 3 encasing the screen 2, and a pen-type stylus 4 for writing on the screen 2. The screen 2 includes a liquid crystal display (LCD) 5 and a translucent transducer pad 6 overlaying the display 5. The transducer pad 6 may be an Indium Tin Oxide (ITO) pad having a membrane type sensor operable to provide an electrical signal indicative of the position on the pad 6 at which the stylus 4 is applying pressure, in excess of a predetermined threshold pressure. Transducer pads provide electrical signals representing the x-y co-ordinates of a point at which pressure is applied locally, by a stylus 4, to a writing surface of the pad. A writing surface is a flexible electrically resistive membrane separated from an electrically conductive base so that the pressure applied by the stylus 4 results in electrical contact between the membrane and the base. Each pair of opposing edges of the membrane may have a voltage applied so that when the stylus 4 applies pressure the potential of the base at the contact point is indicative of a position co-ordinate of the stylus 4.

The housing 3 has power on 7 and off 8 buttons indented within one side of the housing 3, save 9 and new 10 buttons proximate each other on another side, a scroll button 11 built into yet another side of the housing 3, and a recessed “DELETE” button 12 built into the top of the housing 3. A charge port 12, an extra memory slot 13, a Universal Serial Bus (USB) port 14 may be built into the bottom of the housing 3.

The device 1 can be powered on by depressing the power on button 7 and can be turned off by depressing the power off button 8. When powered on, the user may handwrite notes onto the screen 2 with the stylus 4 and then save, and date and time stamp that entry by depressing either the save 9 or new 10 buttons. Depressing the save 9 or new 10 buttons also records the number of the note. Depressing the new button 10 stores the entry and clears the screen 2 for a new entry to be made. The scroll button allows a user to quickly and conveniently find and review his previously entered handwritten notes, addresses, sketches, etc. by scrolling up and down through the pages. By moving the scroll button 11 upwards, the user can access handwritten notes, etc. that were entered earlier in time than the notes that are accessed by moving the scroll button 11 downwards. The entries can be scrolled through quickly by moving the scroll button 11 upwards or downwards fast. The user can scroll to an entry which he desires to delete with the scroll button 11 and then depress the recessed “DELETE” button 12, using the stylus 4, and thereby erase the desired entry from memory storage. The “DELETE” button 12 is configured such that the user must push the tip of the stylus 4 down onto the button 12 to delete an entry. This makes it almost impossible to lose or accidentally delete a note.

The charge port 12 allows the device 1 to be recharged externally. The extra memory slot 13 can be an SD slot, which acts as an SD card reader. The USB port 14 can receive a USB flash drive (i.e. thumb drive). Both SD cards and USB flash drives allow memory storage on a removable device which can be securely kept should the digital notepad 1 be lost, and they may be used to transfer their contents into another device 1. The SD card interface 26 and USB interface 24 access the bus 19 to allow for notes and other handwritten data to be transferred from the digital notepad 1 to a personal computer (PC).

The device 1 is preferably square-shaped with sides that are 3.75 inches in length. These key-fobbed dimensions allow one to easily stow the device 1 within a pocket, purse, or within the palm of one's hand.

The housing 3 is preferably molded of plastic and is shaped to fit the screen 2 and associated electronic components. The front of the housing 3 frames the screen 2, such that the screen 2 is visible to the user, and the rear of the housing 3 fully covers the rear side of the screen 2. The rear side of the housing 3 is molded with a diagonal slot 15 extending from one corner of the housing 3 to an opposing corner. This slot 15 is designed to hold the stylus 4. A longer stylus 4 may be secured in this diagonal holder 15 than if the holder 15 merely extended the length of one side. Thus, the stylus 4 is preferably 5.03 inches in length. A long stylus 4 allows even the least dexterous user to easily handwrite notes onto the screen 2 using the stylus 4.

In an alternate embodiment of the invention as shown in FIG. 2, a rubber ring 16 is attached to the rear side of the housing 3 using any suitable means. For example, the rubber ring 16 can be magnetically connected to the housing 3, or the ring 16 can include a key which fits into a corresponding slot on the rear of the housing 3. Alternately, the rubber ring 16 can snap-fit to the housing 3. The ring 16 can be looped over the user's fingers or wrist to allow use of the device as a teleprompter for the user while he is making a presentation at a business meeting, family gathering, in front of a judge and/or jury during a trial or in an other suitable setting. The ring 16 also allows the user to wear the device 1 on his fingers or arm and tilt the device 1 to improve the viewing angle and reduce glare, as well as easily transport the device 1.

In yet another embodiment of the embodiment, a magnetic strip (not shown) is adhered to the rear side of the housing 3 which permits the digital notepad 1 to be mounted to a number of different surfaces including but not limited to, a dashboard of a car, a PC, a desk, a refrigerator, a phone station, a counter top, a desk top, and doors.

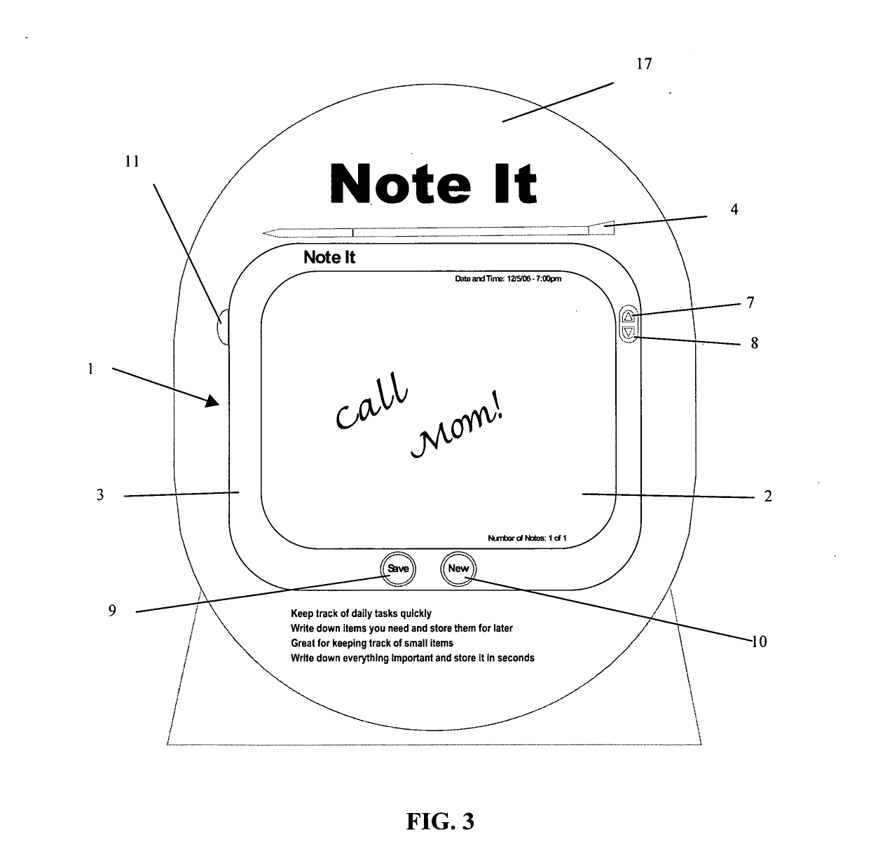

The digital notepad 1 may be enclosed within plastic packaging 17 as shown in FIG. 3 so that the notepad 1 can be easily displayed for marketing and sales purposes.

The design of the present invention 1 is economical to manufacture and sell to provide for widespread use. One skilled in the art will understand that device 1 may be made in various different sizes and shapes to suit the needs of the user, without departing from the spirit and scope of the invention.

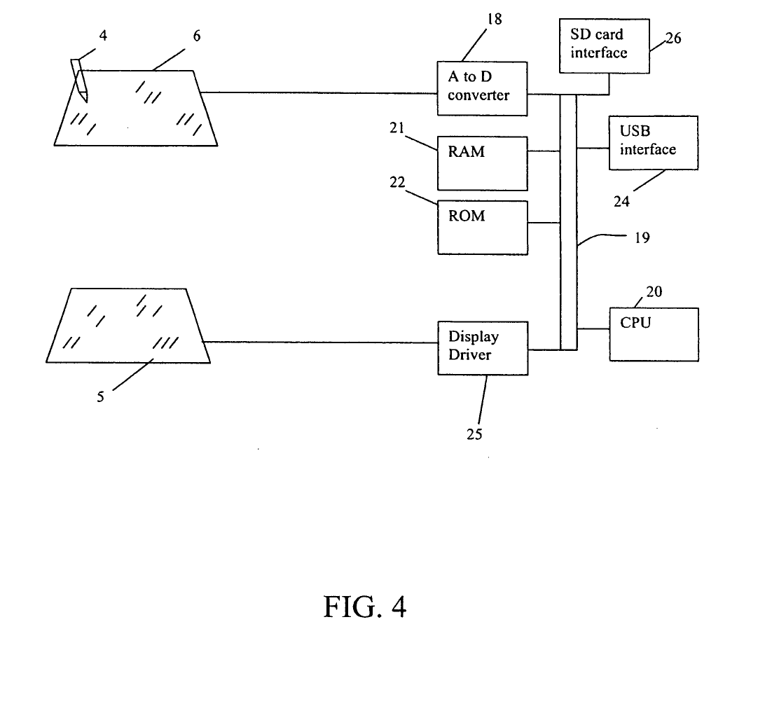

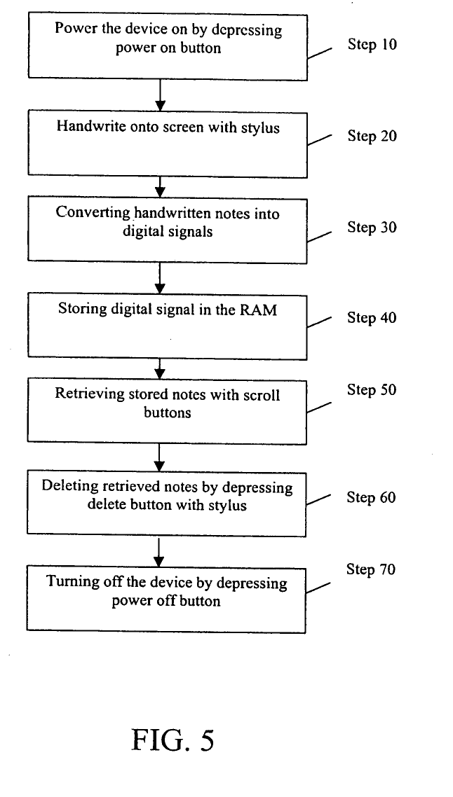

FIG. 4 is a schematic block diagram illustrating the major circuitry of the device 1. The electrical signals from the transducer pad 6 are supplied to an A to D converter 18 feeding a data path or system bus 19. A central processing unit (CPU) 20 is connected for bidirectional data flow to the bus 19, as is a Random Access Memory (RAM) 21. A Read Only Memory (ROM) 22 is also connected to bus 19, being programmed with the operating system for the device 1, which is executed by microprocessor or CPU 20. The operating system implements a concise (memory frugal) command set as necessary to implement the program flow described below in regard to FIG. 5. Conventional operating systems may be programmed to do this, for example, the Vector OS™ is a streamlined operating system that will suffice for present purposes. Alternatively, a dedicated operating system may be used. The microprocessor or CPU 20 controls all of the data displayed on the screen 2. CPU 20 provides all control signals via bus 19. RAM 21 stores the user input, and may be a non-volatile device such as an EEPROM or magnetic bubble memory, such as the 4 megabit 7114 manufactured by Intel Corp. The RAM 21 can store up to 1500 electronic pages of notes. The digital signals from the A to D converter 18 are stored in the RAM 21 as electronic files or pages. CPU 20 may be a multi-purpose microprocessor such as the Z80 manufactured by Zilog Microcomputers or the 8088 manufactured by Intel Corp, or alternatively a more dedicated processor such as a programmable logic array. The device 1 also includes an internal power supply, which may include a rechargeable lithium ion microcell battery (not shown), which provides the power required by the various components such as CPU 20 and ROM 22. The local power source permits the device 1 to be completely portable, and yet still allows locally entered data to be sent to the CPU 20 for recording. Additionally, the device 1 includes a USB interface 24 connected to bus 19 for the inputting and offloading of data. The CPU 20 generates signals to the display driver 25 which results in representational graphics being displayed. A display driver 25 connected to bus 19 drives the LCD display 2 which is preferably a supertwist type display or a neutralized twisted nematic display. The detailed electronic design of these components would be a routine matter for one skilled in the art.

The use of the device 1 will now be described with combined reference to FIGS. 1 and 5. The device 1 is powered on by depressing the power on button 7 (step 10). The user then handwrites writes on the screen 2 with the stylus 4 (step 20). The device 1 converts the handwritten notes into pixilated digital signals (step 30). The device 1 then stores the digital signals in the RAM 21 (step 40) in a sequential queue where they can be retrieved on a first-in-first-out (FIFO) basis. The user may retrieve stored notes with the scroll button 11 (step 50). The user may delete retrieved notes by depressing the “DELETE” button 12 with the stylus 4 (step 60). Finally, the user may turn the device 1 off by depressing the power off 8 button (step 70).

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A portable digital notepad comprising:
a touch screen display;
a housing enclosing said touch screen display;
a stylus for handwritten note entry on said touch screen display;
a processor and memory for digitizing said handwritten notes and for storing said digitized notes in a queue; and
a scroll button mounted on said housing for recalling said digitized notes from said queue in first-in-first-out (FIFO) order and for displaying said notes on said touch screen display.

2. A portable digital notepad comprising according to claim 1, further comprising on/off, and save and new (note) buttons.

3. A portable digital notepad comprising according to claim 2, wherein a user can handwrite a note onto the touch screen display with a stylus and then save, and date and time stamp that note by depressing the save or new buttons.
